(19) United States
(12) Patent Application Publication
(10) Pub. No.: US 2016/0269758 A1
(43) Pub. Date: Sep. 15, 2016

(54) DRAWING OPERATION REPLAY IN MEMORY

(71) Applicant: UTC FIRE AND SECURITY AMERICAS CORPORATION, INC., Bradenton, FL (US)

(72) Inventor: Vamshikrishna Kanisetty, Hyderabad (IN)

(21) Appl. No.: 15/033,939

(22) PCT Filed: Nov. 4, 2014
(86) PCT No.: PCT/US2014/063838

§ 371 Date: May 3, 2016

Related U.S. Application Data
(60) Provisional application No. 61/900,016, filed on Nov. 5, 2013.

(51) Int. Cl. H04N 21/2343; H04N 21/218; H04N 21/234; H04N 21/2747

(52) U.S. Cl. CPC H04N 21/2343; H04N 21/2747; H04N 21/2181; H04N 21/23418

(57) ABSTRACT

Embodiments are directed to drawing operation replay in memory for video format conversion. A method includes intercepting an operating system graphics call by rendering a video stream. The operating system graphics call is passed to a video processing module. A virtual device context is set as a target of a drawing command associated with the operating system graphics call. The drawing command is replayed on the virtual device context in memory. A screen capture operation of the virtual device context is performed after the replaying of the drawing command on the virtual device context. An output of the screen capture operation is encoded into a video streaming protocol.

### BACKGROUND

The subject matter disclosed herein relates to video display systems, and in particular, to drawing operation replay in memory for video format conversion.

Legacy digital video recorders (DVRs) use custom software development kits (SDKs) or ActiveX controls to connect to and render the images on a display. These interfaces may not support standard video encoding or transport protocols and instead use a black box approach for connecting to DVRs and rendering the images. In order to support video on devices that support standard video formats and protocols, such as handheld devices, the video needs to be converted to a standard format. A video format provides an organized representation of video data. Video formats can be proprietary or standard, such as MPEG2/H262. Proprietary formats can only be decoded by vendor-specific tools as details of proprietary formats are not publicly available.

U.S. Pat. No. 8,417,090 to Fleming describes transmitting and receiving surveillance video and/or alarm data and converting proprietary video formats into a single, standardized format. In Fleming, a remote viewer connects to a central server; the server then downloads live images from DVR units: and the images are converted to a standard format and then presented back to the viewer as standard images or as a standardized video stream. Fleming, converts and processes the video within the DVRs rather than converting and processing the video at the central server. While Fleming shifts the format conversion burden from the remote viewers, Fleming, requires modifications to the DVRs.

### BRIEF SUMMARY

An embodiment is directed to a method for drawing operation replay in memory for video format conversion. The method includes intercepting an operating system graphics call rendered by a third-party vendor software development kit. The operating system graphics call is re-rendered in memory without any actual images being shown on a display and then passed to a video processing module. A virtual device context is set as a target of a drawing command associated with the operating system graphics call. The drawing command is replayed on the virtual device context in memory. A screen capture operation of the virtual device context is performed after the replaying of the drawing command on the virtual device context. An output of the screen capture operation is encoded into a video streaming protocol.

An embodiment is directed to a video server for drawing operation replay in memory for video format conversion. The video server includes memory and processing circuitry. The memory includes a virtual device context. The processing circuitry is configured to intercept an operating system graphics call from a video stream and pass the operating system graphics call to a video processing module. The processing circuitry is also configured to set the virtual device context as a target of a drawing command associated with the operating system graphics call, replay the drawing command on the virtual device context, perform a screen capture operation of the virtual device context after the replaying of the drawing command on the virtual device context, and encode an output of the screen capture operation into a video streaming protocol.

An embodiment is directed to a system for drawing operation replay in memory for video format conversion. The system includes a video processing module configured to intercept operating system graphics calls from video streams fetched by a plurality of third-party software development kits. The third-party software development kits are configured to access a plurality of digital video recorders having different video formats. A virtual device context is configured to receive replayed drawing commands associated with the intercepted operating system graphics calls. A screen capture module is configured to perform a screen capture operation of the virtual device context based on the replaying of the drawing commands on the virtual device context. An encoder is configured to encode an output of the screen capture operation into standard video format for supporting standard video streaming protocol.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating a system in accordance with one or more embodiments;

FIG. 2 illustrates a dataflow diagram in accordance with one or more embodiments; and

FIG. 3 illustrates a process in accordance with one or more embodiments.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for drawing operation replay in memory for video format conversion. Embodiments capture moving images that are intended to be rendered on a target drawing surface, such as a display, by intercepting drawing commands associated with an operating system graphics call made by an application and replaying the same commands in memory on a virtual device context. Video rendered to memory is captured and convened into a standard format that can be streamed using protocols such as hypertext transfer protocol (HTTP) streaming or real-time transport protocol (RTP) streaming. Video streaming protocols enable distribution of video over a network.

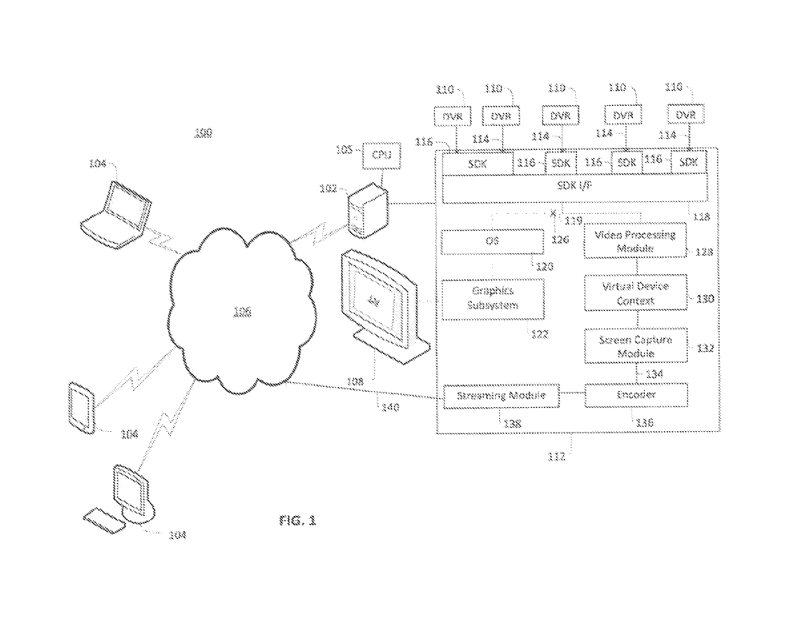

Referring to FIG. 1, an exemplary system 100 is shown. The system 100 is shown as including a video server 102 configured to stream video to one or more video clients 104 via a network 106. The video server 102 is a high-speed processing device (e.g., a mainframe computer, workstation, personal computer, embedded computing device, or the like) including processing circuitry 105 (e.g., a computer processor/CPU) capable of reading and executing instructions, and handling interactions with various components of the system 100. The video clients 104 may be embodied in any type of computing or video display devices known in the art, such as a laptop, tablet computer, mobile device, personal computer, workstation, server, and the like. The network 106 may be any type of communications network known in the art and can include a combination of wireless, wired, and/or fiber optic links.

The video server 102 interfaces to at least one display 108 and a plurality of digital video recorders (DVRs) 110. The DVRs 110 may be provided by a number of different vendors using different proprietary formats for video streams 114. Memory 112 of the video server 102 can hold a number of programs and data to support video streaming. A number of third-party software development kits (SDKs) 116 may be stored in memory 112 as applications and executed by the processing circuitry 105 to interface with the DVRs 110 using vendor-specific proprietary formats. Fetching and decoding of the video streams 114 by the third-party SDKs 116 may be managed through an SDK interface 118. The SDK interface 118 can interact with an operating system 120 to make operating system graphics calls 119 to pass drawing commands for rendering decoded video as images from the video streams 114 through a graphics subsystem 122 to a display window 124 on the display 108.

Embodiments intercept operating system graphics calls 119 from the video streams 114 at intercept point 126 and pass the operating system graphics calls 119 to a video processing module 128. A virtual device context 130 is set as a target of drawing commands associated with the operating system graphics calls 119. The virtual device context 130, which may also be referred to as a frame buffer, is an area in memory 112 where drawings (for example, images) are made in accordance with an embodiment. Drawing that are made in the virtual device context 130 exist only in memory 112 and are not visible to a user. The drawing commands are replayed on the virtual device context 130 in memory 112 of the video server 102. A screen capture operation is performed by a screen capture module 132 of the virtual device context 130 after the replaying of the drawing commands on the virtual device context 130. An output 134 of the screen capture operation from the screen capture module 132 is encoded by encoder 136, passed to a streaming module 138, and output into a video streaming protocol 140. Video in the video streaming protocol 140 can be sent over the network 106 to one or more of the video clients 104 using an industry standard. protocol.

In embodiments, the DVRs 110 provide non-standard video streams 114 in proprietary formats that may not be directly converted to standard video formats to support rendering videos by the various video clients 104. Transcoding is a technique that can be used to convert one video format to another, but this is only possible if the video format provided by the DVRs 110 is a known, e.g., a published format. Raw video data from the DVRs 110 may be encrypted such that direct processing of the raw video data is not possible. In cases where the video format is not known outside of the third-party SDKs 116, the video streams 114 cannot be directly converted into a standard format by the video processing module 128. Rather than attempting to convert the video format of the video streams 114, the video processing module 128 intercepts and redirects low-level drawing commands associated with operating system graphics calls 119 intended for the operating system 120 and renders the video in the virtual device context 130 in memory 112. Application programming interface (API) hooking can be used, for example, at the intercept point 126 to redirect operating system graphics calls 119 from the video streams 114 to the video processing module 128.

On-screen video capture is a technique where drawing operations on a specific window or entire desktop can be captured and stored, such as operations targeting the display window 124. However, on-screen video capture has limitations where the display window 124 needs to be visible on the display 108 and all drawing operations are shown. This consumes display resources and becomes unmanageable when supporting multiple DVRs 110 in parallel. Additionally, any overlapping windows can hinder the drawing operations, particularly if multiple screen captures are performed in parallel. Exemplary embodiments use the virtual device context 130 to store drawing operations for the screen capture module 132, where replaying of the drawing commands on the virtual device context 130 and the screen capture operation of the virtual device context 130 are performed absent output of the drawing commands and resulting images to the display 108. In other words, the screen capture module 132 performs screen capture operations in the memory 112, and there is no output to the display 108. Replaying of drawing, instructions creates a virtual copy of the video output in the memory 112 rather than directing the video output to the display 108. Replaying retains the state of images in the virtual device context 130, where the screen capture module 132 can operate as if the images are being captured from the display 108 but without the risk of window overlap or actual rendering delays. Had the hooking/interception not been performed, video output would have been rendered to the display 108. Instead, drawing operations associated with rendering video output are diverted into the virtual device context 130 in memory 112, where transcoding from a drawn image in memory 112 into a standard format is performed.

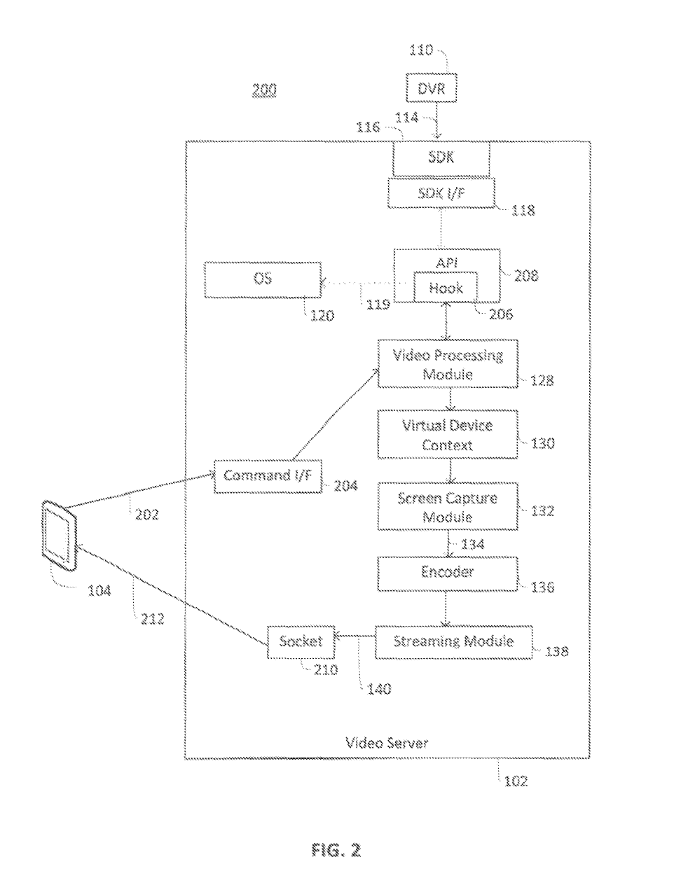

FIG. 2 illustrates a dataflow diagram 200 in accordance with one or more embodiments. One of the video clients 104 can make a request 202 to view video from one of the DVRs 110. The request 202 may be processed by a command interface 204 of the video server 102, which can access the video processing module 128. The video processing module 128 can enable or configure hooking code 206 in an API 208. The API 208 may be configured to pass operating system graphics calls 119 to operating system 120. The video processing module 128 is configured to intercept the operating system graphics calls 119 from video streams 114 fetched by a plurality of third-party SDKs 116 via SDK interface 118 and hooking code 206. The hooking code 206 refers to any redirection technique to capture lower level drawing commands that are otherwise intended for the operating system 120. In exemplary embodiments, the third-party SDKs 116 do not convert video into a format that is directly usable by the streaming module 138, nor do the third-party SDKs 116 decode the video streams 114. The third-party SDKs 116 accept credentials for DVRs 110 and attempt to render video directly on the display 108. Rather than allow video from the third-party SDKs 116 to reach the display 108, the operating system graphics calls 119 made by the third-party SDKs 116 are intercepted and redirected to the virtual context 130.

The video processing module 128 can direct the operating system graphics calls 119 with associated drawing commands to the virtual device context 130. The virtual device context 130 is configured to receive replayed drawing commands associated with the intercepted, operating system graphics calls 119. The screen capture module 132 is configured to perform a screen capture operation of the virtual device context 130 based on the replaying. of the drawing commands on the virtual device context 130. Replay of the drawing commands on the virtual device context 130 and the screen capture operation are performed absent output of the drawing commands to the display 108 of FIG. 1. The encoder 136 encodes output 134 of the screen capture module 132 into a standardized encoding format for the streaming module 138 to send encoded output using a video streaming protocol 140. A socket 210 supporting streaming is established with the video client 104 for the video client 104 to receive streaming video 212 in an industry standard format. Accordingly, the video client 104 can avoid installing vendor specific software to handle encoding/decoding details for a plurality of DVRs 110 using various vendor-specific formats for the video streams 114.

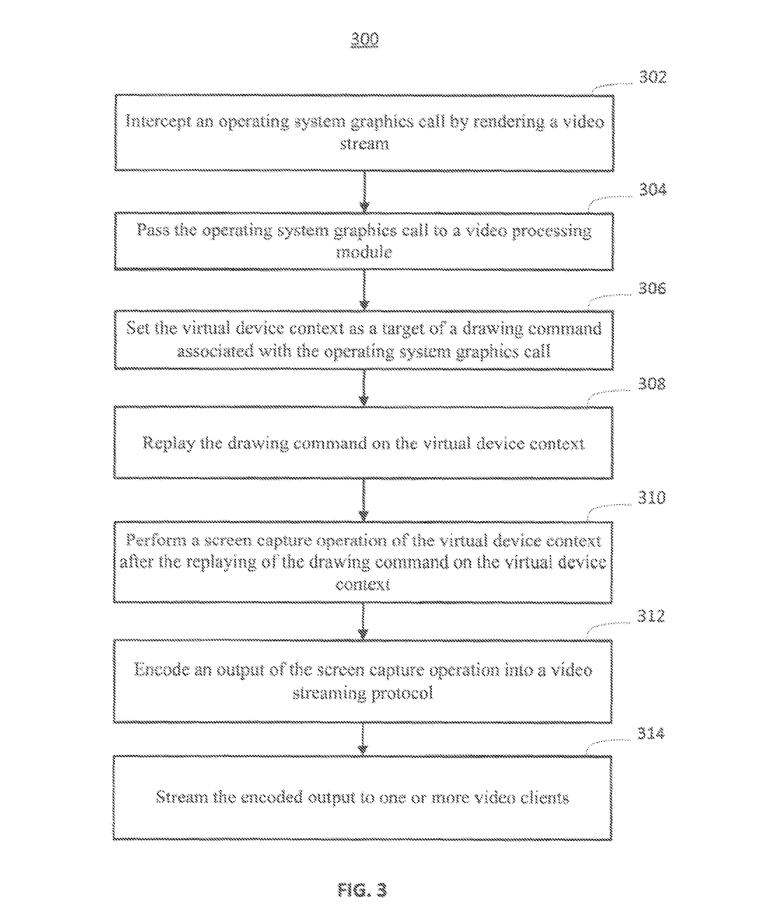

FIG. 3 illustrates a process 300 in accordance with one or more embodiments. The process 300 is described in reference to FIGS. 1-3 and need not be performed in the precise order as depicted in FIG. 3. At block 302, an operating system graphics call 119 for a video stream 114 is intercepted on a video server 102. Interception of the operating system graphics call 119 may be performed using application programming interface hooking, e.g., hooking code 206, by the video server 102. The video stream 114 may be fetched and decoded by a third-party SDK 116 where the video stream 114 is in a proprietary or unknown format. The operating system graphics call 119 rendered by the third-party SDK 116 is re-rendered in memory 112 without displaying images on the display 108.

At block 304, the operating system graphics call 119 is passed to a video processing module 128. The video processing, module 128 may be linked to a plurality of third-party SDKs 116. The video processing module 128 is configured to intercept operating system graphics calls 119 front the third-party SDKs 116. The third-party SDKs 116 may be associated with DVRs 110 having different video formats.

At block 306, a virtual device context 130 is set as a target of a drawing command associated with the operating system graphics call 119. At block 308, the drawing command is replayed on the virtual device context 130 in memory 112 of the video server 102. At block 310, a screen capture operation of the virtual device context 130 is performed after the replaying of the drawing command on the virtual device context 130. At block 312, an output 134 of the screen capture operation is encoded into a video streaming protocol 140. The replaying of the drawing command on the virtual device context 130 and the screen capture operation of the virtual device context 130 are performed absent output of the drawing command to a display 108. At block 314, the encoded output is streamed to one or more video clients 104 as streaming video 212. The video streaming protocol 140 may be an industry standard protocol, such as HTTP or RTP streaming.

Embodiments of the disclosure may be tied to one or more particular machines. For example, one or more devices, apparatuses, systems, or architectures may be configured to perform drawing operation replay in memory for video format conversion. Technical effects include converting proprietary or unknown video formats to an industry standard streaming protocol. The captured video from using this technique can be encoded to standard formats to support streaming to industry standard based video players or devices. Embodiments enable maintenance and updates to SDKs provided by various vendors to he deployed to a video server, thus reducing the need to maintain the updates on multiple video clients.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may he implemented as one or more apparatuses, systems, and/or methods. In sonic embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method for drawing operation replay in memory for video format conversion, comprising:
intercepting an operating system graphics call by rendering a video stream;
passing the operating system graphics call to a video processing module;
setting a virtual device context as a target of a drawing command associated with the operating system graphics call;
replaying the drawing command on the virtual device context in memory;
performing a screen capture operation of the virtual device context after the replaying of the drawing command on the virtual device context; and
encoding an output of the screen capture operation into a video streaming protocol.

2. The method of claim 1, wherein the video stream is in a proprietary or unknown format, and the video streaming protocol is an industry standard protocol.

3. The method of claim 1, wherein the video stream is fetched and decoded by a third-party software development kit.

4. The method of claim 1, further comprising:
linking the video processing module to a plurality of third-party software development kits, the video processing module configured to intercept operating system graphics calls from the third-party software development kits.

5. The method of claim 4, wherein the third-party software development kits are associated with digital video recorders having different video formats.

6. The method of claim 1, wherein the replaying of the drawing command on the virtual device context and the screen capture operation of the virtual device context are performed absent output of the drawing command to a display.

7. The method of claim 1, wherein the intercepting is performed using application programming interface hooking.

8. The method of claim 1, further comprising streaming the encoded output to one or more video clients.

9. A video server for drawing operation replay in memory for video format conversion, comprising:
memory comprising a virtual device context; and
processing circuitry configured to:
intercept an operating system graphics call by rendering a video stream;
pass the operating system graphics call to a video processing module;
set the virtual device context as a target of a drawing command associated with the operating system graphics call;
replay the drawing command on the virtual device context;
perform a screen capture operation of the virtual device context after the replaying of the drawing command on the virtual device context; and
encode an output of the screen capture operation into a video streaming protocol.

10. The video server of claim 9, wherein the video stream is in a proprietary or unknown format, and the video streaming protocol is an industry standard protocol.

11. The video server of claim 9, wherein the video stream is fetched and decoded by a third-party software development kit.

12. The video server of claim 9, wherein the video processing module is linked to a plurality of third-party software development kits, and the video processing module is configured to intercept operating, system graphics calls from the third-party software development kits.

13. The video server of claim 12, wherein the third-party software development kits are associated with digital video recorders having different video formats.

14. The video server of claim 9, wherein the replay of the drawing command on the virtual device context and the screen capture operation of the virtual device context are performed absent output of the drawing command to a display.

15. The video server of claim 9, wherein interception of the operating system graphics call is performed using application programming interface hooking.

16. The video server of claim 9, wherein the processing circuitry is further configured to stream the encoded output to one or more video clients.

17. A system for drawing operation replay in memory for video format conversion, comprising:
a video processing module configured to intercept operating system graphics calls for video streams fetched by a plurality of third-party software development kits, the third-party software development kits configured to access a plurality of digital video recorders having different video formats;
a virtual device context configured to receive replayed drawing commands associated with the intercepted operating system graphics calls;
a screen capture module configured to perform a screen capture operation of the virtual device context based on the replaying of the drawing commands on the virtual device context; and
an encoder configured to encode an output of the screen capture operation into a video streaming protocol.

18. The system of claim 17, wherein the video formats are proprietary or unknown formats, and the video streaming protocol is an industry standard protocol.

19. The system of claim 17, wherein replay of the drawing commands on the virtual device context and the screen capture operation are performed absent output of the drawing commands to a display.

20. The system of claim 17, wherein interception of the operating system graphics calls is performed using application programming interface hooking.
